(19) United States
(12) Patent Application Publication
(10) Pub. No.: US 2019/0359286 A1
(43) Pub. Date: Nov. 28, 2019

(54) Bicycle Chainring

(71) Applicants: Tomonari Ichikawa, Hyogo (TW); Kuang Yang Liao, Taichung City (TW)

(72) Inventors: Tomonari Ichikawa, Hyogo (TW); Kuang Yang Liao, Taichung City (TW)

(21) Appl. No.: 16/416,444

(22) Filed: May 20, 2019

(30) Foreign Application Priority Data
May 25, 2018 (TW) 107206951

(51) Int. Cl. B62M 9/10; F16H 55/30

(52) U.S. Cl. CPC B62M 9/105; F16H 55/30

(57) ABSTRACT

A bicycle anti-stripping chainring has a body, multiple wide teeth, and multiple narrow teeth. The wide teeth and the narrow teeth are alternately formed on and protrude from an outer periphery of the body at spaced intervals. Each wide tooth has a width wider than a wide of each narrow tooth. At least one of the wide teeth has two side faces inclined in a same direction and staggered a tangential direction of the body. With the arrangement of the wide teeth and the narrow teeth of the present invention, a chain can engage with the different widths of the wide teeth and the narrow teeth tightly, and this can provide a anti-stripping effect to the chain when a bicycle is in use.

### BACKGROUND OF THE INVENTION

### Field of the Invention

The present invention relates to a bicycle chainring, and more particularly to a bicycle anti-stripping chainring that can be tightly engaged with a chain to avoid the chain disengaging from the bicycle anti-stripping chainring easily.

### Description of Related Art

A conventional bicycle is used a crank to connect with a chainring, and a chain is engaged with the chainring and a sprocket set of a rear wheel of the conventional bicycle. So that a user can ride a pedal with the crank to enable the rear wheel to rotate via the chainring and the sprocket set, and the conventional bicycle can be driven to move forwardly.

The chainring of the conventional bicycle has multiple teeth formed on an outer periphery of the chainring to engage with the chain. However, the chain of the conventional bicycle has multiple inner links and multiple outer links that are alternately pivoted back and forth, and a space between each inner link is narrower than a space of each outer link. When the teeth of the chainring with same size engage with the chain, a large gap is generated between each outer link and a corresponding tooth of the chainring. When the conventional bicycle performs a downhill race or a cross-country sway with a larger changes of tension, the chain is easily stripped from the chainring. To overcome the shortcomings, the present invention tends to provide a bicycle anti-stripping chainring to mitigate or obviate the aforementioned problem.

### SUMMARY OF THE INVENTION

The main objective of the invention is to provide a bicycle anti-stripping chainring that can be tightly engaged with a chain to avoid the chain disengaging from the bicycle anti-stripping chainring easily.

The bicycle anti-stripping chainring in accordance with the present invention has a body, multiple wide teeth, and multiple narrow teeth. The wide teeth and the narrow teeth are alternately formed on and protrude from an outer periphery of the body at spaced intervals.

Each wide tooth has a width wider than a wide of each narrow tooth. At least one of the wide teeth has two side faces inclined in a same direction and staggered a tangential direction of the body.

With the arrangement of the wide teeth and the narrow teeth of the present invention, a chain can engage with the different widths of the wide teeth and the narrow teeth tightly, and this can provide a anti-stripping effect to the chain when a bicycle is in use.

### BRIEF DESCRIPTION OF THE DRAWINGS

FIG. 1 is a perspective view of a first embodiment of a bicycle anti-stripping chainring in accordance with the present invention;

FIG. 2 is an enlarged perspective view of the bicycle anti-stripping chainring in FIG. 1;

FIG. 3 is an operational top view of the bicycle anti-stripping chainring in FIG. 1;

FIG. 4 is a top view of a second embodiment of a bicycle anti-stripping chainring in accordance with the present invention;

FIG. 5 is a top view of a third embodiment of a bicycle anti-stripping chainring in accordance with the present invention;

FIG. 6 is a top view of a fourth embodiment of a bicycle anti-stripping chainring in accordance with the present invention;

FIG. 7 is a perspective view of a fifth embodiment of a bicycle anti-stripping chainring in accordance with the present invention; and

FIG. 8 is a top view of the bicycle anti-stripping chainring in FIG. 7.

### DETAILED DESCRIPTION OF PREFERRED EMBODIMENT

Other objects, advantages and novel features of the invention will become more apparent from the following detailed description when taken in conjunction with the accompanying drawings.

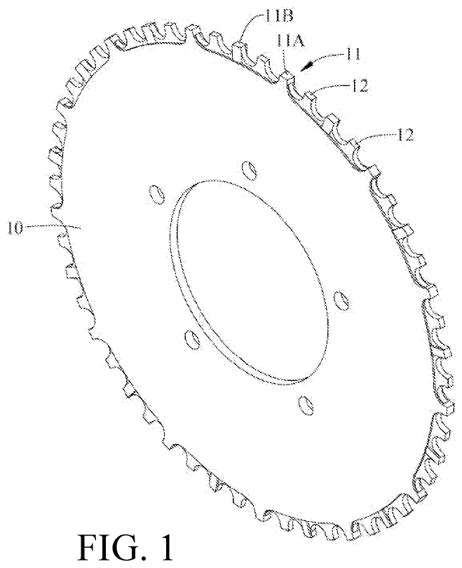

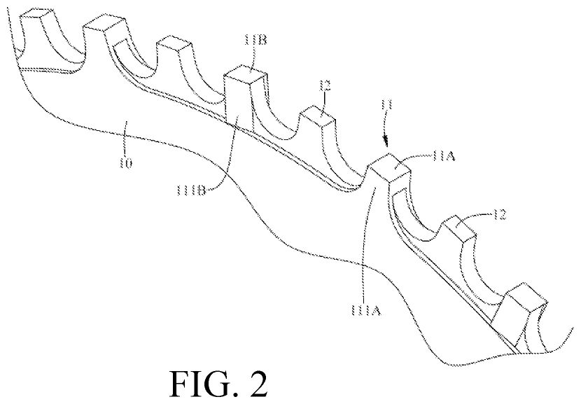

With reference to FIGS. 1 to 3, a first embodiment of a bicycle anti-stripping chainring in accordance with the present invention comprises a body 10, multiple wide teeth 11, and multiple narrow teeth 12. The wide teeth 11 and the narrow teeth 12 are alternately formed on and protruded from an outer periphery of the body 10 at spaced intervals. The amount of the wide teeth 11 is same as the amount of the narrow teeth 12. A width of each wide tooth 11 is wider than a width of each narrow tooth 12. For example, the bicycle anti-stripping chainring of the present invention has 52 teeth, so that 26 wide teeth 11 and 26 narrow teeth 12 are formed alternately around the outer periphery of the body 10, and the width difference between the wide teeth 11 and the narrow teeth 12 is less than 5%.

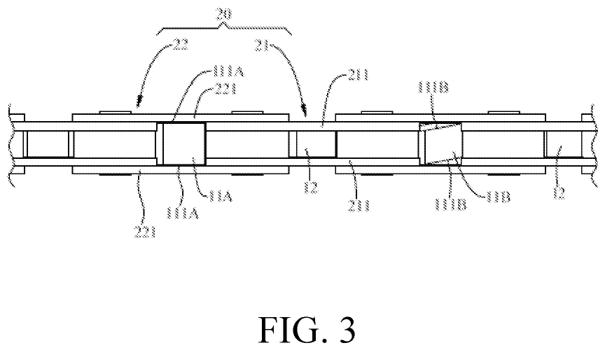

With further reference to FIG. 3, in the first embodiment of the present invention, the amount of the wide teeth 11 is divided into a first wide teeth 11A and a second wide teeth 11B, and the first wide teeth 11A and the second wide teeth 11B are alternately arranged with each other. Each one of the first wide teeth 11A has two side faces 111A, and the side faces 111A of each first wide tooth 11A are parallel to a tangential direction of the body 10. A width of each first wide tooth 11A is equal to a distance between the two side faces 111A of the first wide tooth 11A. Each one of the second wide teeth 11B has two side faces 111B, and the two side faces 111B are inclined in a same direction, and at least two of the side faces 111B are partially staggered the tangential direction of the body 10. A width of each second wide tooth 11B is equal to a distance between the two side faces 111B of the second wide tooth 11B.

With reference to FIG. 3, when the first embodiment of the present invention is used, a chain 20 is mounted around the bicycle anti-stripping chainring and has multiple inner links 21 and multiple outer links 22 alternately and pivotally connected back and forth. The chain 20 engages with the wide teeth 11 and the narrow teeth 12 that disposed around the body 10. A width of each inner link 21 is narrower than a wide of each outer link 22. Each narrow tooth 12 engages with one of the inner links 21 between two inner link panels 211 of the corresponding inner link 21, and each wide tooth 11 engages one of the outer links 22 between two outer link panels 221 of the corresponding outer link 22. Since each wide tooth 11 having a width wider than a width of each narrow tooth 12 engages between two outer link panels 221 of a corresponding outer link that has a width wider than a width of two inner panels 211 of each inner link 21, then the cooperation between the wide teeth 11, the narrow teeth 12, and the chain 20 is relatively tight, and this can avoid the chain 20 stripping from the body 10 when shaking or receiving a large change in the magnitude of tension.

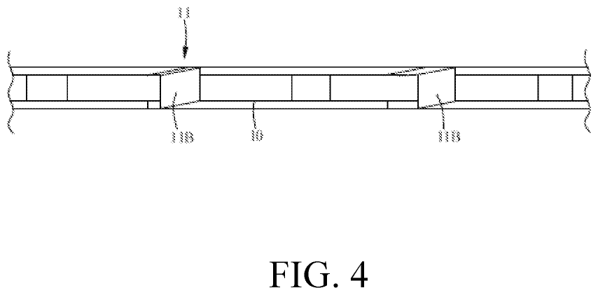

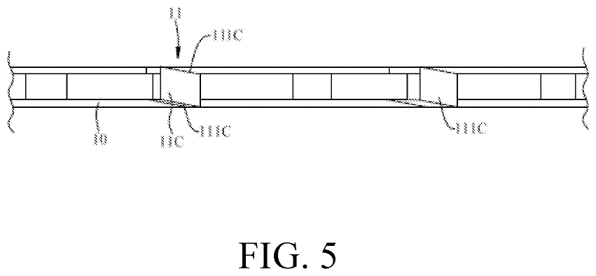

In the first embodiment of the bicycle anti-stripping chainring in accordance with the present invention, the wide teeth 11 comprise first wide teeth 11A and second wide teeth 11B. With reference to FIG. 4, in a second embodiment of the bicycle anti-stripping chainring in accordance with the present invention, all of the wide teeth 11 disposed on the body 10 are second wide teeth 11B. With reference to FIG. 5, in a third embodiment of the bicycle anti-stripping chainring in accordance with the present invention, all of the wide teeth 11 are third wide teeth 11C, and each third wide tooth 11C has two side faces 111C inclined in a same direction, and at least two of the side faces 111C are partially staggered the tangential direction of the body 10. The incline direction of the side faces 111C of each third wide tooth 11C is opposite to the inclined direction of the side faces 111B of each second wide tooth 11B.

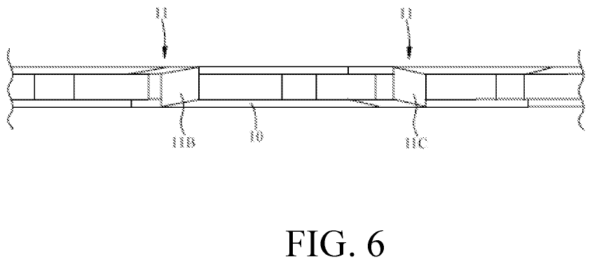

In the second embodiment of the present invention, the wide teeth 11 disposed on the body 10 are all second wide teeth 11B, in the third embodiment of the present invention, the wide teeth 11 disposed on the body 10 are all third teeth 11C. With reference to FIG. 6, in a fourth embodiment of the bicycle anti-stripping chainring in accordance with the present invention, the wide teeth 11 comprise multiple second wide teeth 11B and multiple third wide teeth 11C. The amount of the second wide teeth 11B is equal to the amount of the third wide teeth 11C, and the second wide teeth 11B and the third wide teeth 11C are formed alternately around the outer periphery of the body 10 at spaced intervals.

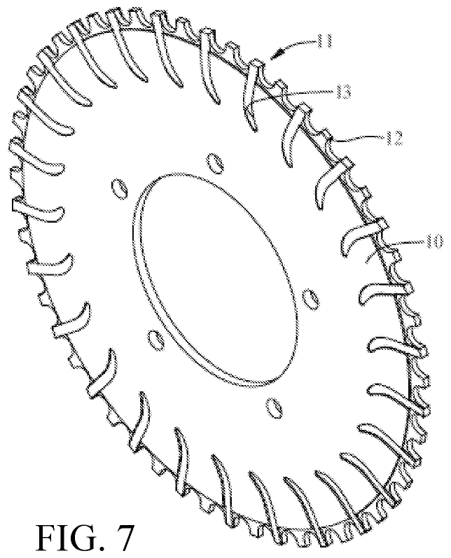

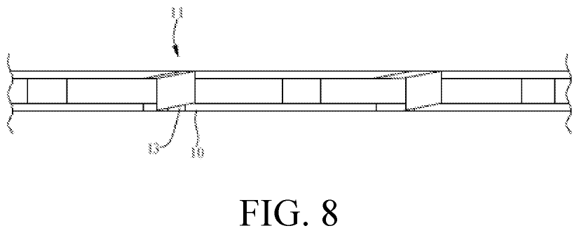

With reference to FIGS. 7 and 8, in a fifth embodiment of the bicycle anti-stripping chainring in accordance with the present invention, multiple wide teeth 11 and multiple narrow teeth 12 are formed alternately around the outer periphery of the body 10 at spaced intervals. The shape and arrangement of each wide tooth 11 can be the same as those in the first, second, third, and fourth embodiments of the present invention. A width of the body 10 is wider than a width of each wide tooth 11, and the body has a sidewall and multiple mud-guiding grooves 13. The mud-guiding grooves 13 are formed in the sidewall of the body 10 and respectively align with the wide teeth 11, and each mud-guiding groove 13 has a distal end and a curved direction. The distal end of each mud-guiding groove 13 is closed and extends to a center of the body 10. The curved directions of the mud-guiding grooves are aligned with the same direction such a clockwise direction or a counterclockwise direction.

When the chain 20 engages with the wide teeth 11 and the narrow teeth 12 of the fifth embodiment of the present invention, the mud on the chain 20 can be excluded through the mud-guiding grooves 13 to avoid the mud accumulating between the wide teeth 11, the narrow teeth 12, and the chain 20. So that the chain 20 can stably engage with the wide teeth 11 and the narrow teeth 12 when rotating, thereby further preventing the chain 20 from being stripping.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

[Reference Signs]

| | |
|---|---|
| 10 Body | 11 Wide teeth |
| 11A The first wide teeth | 11B The second wide teeth |
| 11C The third wide teeth | 111A Side faces |
| 111B Side faces | 111C Side faces |
| 12 Narrow tooth | 13 Mud-guiding grooves |
| 20 Chain | 21 Inner links |
| 211 Inner panels | 22 Outer links |
| 221 Outer link panels | |

What is claimed is:

1. A bicycle anti-stripping chainring comprising:
a body having an outer periphery and a tangential direction;
multiple wide teeth formed and protruding from the outer periphery of the body at spaced intervals, and each wide tooth having a width and two side faces; and
multiple narrow teeth formed and protruding from the outer periphery of the body, and each narrow tooth disposed between two adjacent wide teeth and having a width narrower than the width of each wide tooth;
wherein at least two of the side faces are inclined in a same direction are partially staggered the tangential direction of the body.

2. The bicycle anti-stripping chainring as claimed in claim 1, wherein
the amount of the wide teeth is equal to the amount of the narrow teeth;
the wide teeth comprise multiple first wide teeth and multiple second wide teeth, and the amount of the first wide teeth is equal to the amount of the second wide teeth;
the first wide teeth and the second teeth are formed alternately around the outer periphery of the body at spaced intervals;
each first wide tooth has two side faces parallel to the tangential direction of the body; and
each second wide tooth has two side faces inclined in a same direction and staggered the tangential direction of the body.

3. The bicycle anti-stripping chainring as claimed in claim 1, wherein
the wide teeth comprise multiple second wide teeth and multiple third wide teeth, and the amount of the second wide teeth is equal to the amount of the third wide teeth;
the second wide teeth and the third teeth are formed alternately around the outer periphery of the body at spaced intervals;
each second wide tooth has two side faces staggered the tangential direction of the body; and
each third wide tooth has two side faces staggered the tangential direction of the body and being opposite to the direction of the side faces of each second wide tooth.

4. The bicycle anti-stripping chainring as claimed in claim 1, wherein
each wide tooth has two side faces inclined in a same direction and staggered the tangential direction of the body; and
the directions of the side faces of the wide teeth are the same.

5. The bicycle anti-stripping chainring as claimed in claim 1, wherein the body has
a width being wider than the wide of each wide tooth;
a sidewall; and
multiple mud-guiding grooves formed in the sidewall of the body and respectively aligning with the wide teeth.

6. The bicycle anti-stripping chainring as claimed in claim 2, wherein the body has
a width being wider than the wide of each wide tooth;
a sidewall; and
multiple mud-guiding grooves formed in the sidewall of the body and respectively aligning with the wide teeth.

7. The bicycle anti-stripping chainring as claimed in claim 3, wherein the body has
a width being wider than the wide of each wide tooth;
a sidewall; and
multiple mud-guiding grooves formed in the sidewall of the body and respectively aligning with the wide teeth.

8. The bicycle anti-stripping chainring as claimed in claim 4, wherein the body has
a width being wider than the wide of each wide tooth;
a sidewall; and
multiple mud-guiding grooves formed in the sidewall of the body and respectively aligning with the wide teeth.

9. The bicycle anti-stripping chainring as claimed in claim 1, wherein a width difference between each wide tooth and each narrow tooth is less than 5%.

10. The bicycle anti-stripping chainring as claimed in claim 2, wherein a width difference between each wide tooth and each narrow tooth is less than 5%.

11. The bicycle anti-stripping chainring as claimed in claim 3, wherein a width difference between each wide tooth and each narrow tooth is less than 5%.

12. The bicycle anti-stripping chainring as claimed in claim 4, wherein a width difference between each wide tooth and each narrow tooth is less than 5%.

13. The bicycle anti-stripping chainring as claimed in claim 5, wherein each mud-guiding groove has
a distal end being closed and extending to a center of the body; and
a curved direction, and the curved directions of the mud-guiding grooves aligning with a clockwise direction or a counterclockwise direction.
